(19) United States
(12) Patent Application Publication
(10) Pub. No.: US 2008/0241806 A1
(43) Pub. Date: Oct. 2, 2008

(54) MEDICAL STUDY SUPPORT APPARATUS AND STUDY LIST DISPLAY METHOD

(75) Inventors: Tomoyo Nomura, Ashigarakami-gun (JP); Yoshihito Nakaya, Ashigarakami-gun (JP); Kouetsu Kikkawa, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,784

(22) Filed: Mar. 31, 2008

(30) Foreign Application Priority Data
Mar. 29, 2007 (JP) 2007-089613

(51) Int. Cl. G09B 23/28

(52) U.S. Cl. 434/262

(57) ABSTRACT

A medical study support apparatus manages study data, and displays a study list on a monitor screen. In the study list, data items on each study, including patient's personal information such as its name, birth date, sex and address as well as study items such as study ID, study date, study type and progress of study, are displayed in a lined for one case after another. The medical study support apparatus cooperates with an electronic chart apparatus. As chart data of a particular patient is displayed on its monitor, the electronic chart apparatus sends a trigger signal to the medical study support apparatus along with ID data of the particular patient. Upon receipt of the trigger signal and the ID data, the medical study support apparatus conceals the personal information on other patients than the particular patient in the study list.

### FIELD OF THE INVENTION

The present invention relates to a medical study support apparatus that displays a list of medical study data on a monitor, and a study list display method.

### BACKGROUND OF THE INVENTION

A medical study support apparatus is known for example from Japanese Laid-open Patent Application No. 2006-263223, which displays medical images that are obtained and recorded for medical studies by medical study devices, i.e. modalities such as a computed radiography (CR) and an endoscope, as well as a list of study data on those patients who had the studies and those who are going to have studies, hereinafter called a study list. The study list shows information on an outline of each study such as the date and the type of study, along with personal information of a patient such as the patient's name, birth date and sex, in the form of a list. As the study list helps doctors to grasp the schedule of studies and availability of reserving new studies, the doctor can coordinate various work schedules, including arrangement of respective study dates and times of patients under examination, arrangement of their examination dates and times according to the schedule of their studies, and preparations in advance to the studies.

With development of computerization of medical information, electronic chart apparatuses digitizing and managing patient's medical records are getting popular. The electronic chart apparatus is often placed in an examination room so that the doctor inputs the medical records as needed during an examination and lets their patients confirm their chart contents displayed on the monitor. Considering efficiency of doctor's work, it is desirable that both the electronic chart apparatus and the medical study support apparatus are installed at doctor's hand, for example, being apposed on the doctor's desk in the examination room.

However, because the study list of the above-mentioned medical study support apparatus displays the personal information of many patients, the doctor needs to pay attention to the request for privacy protection, so that the personal information on other patients cannot be seen by the patient who is being counseled by the doctor in the examination room. As practical protective actions, the doctor closes the display of the study list while the patient is in the examination room, or places the medical study support apparatus apart from the electronic chart apparatus so that the contents of the study list displayed on the medical study support apparatus are not seen by any patient in the examination room.

While the display of the study list is closed, the doctor cannot grasp the study schedule during their examination. Where the medical study support apparatus is placed so much apart from the electronic chart apparatus that the study list is not seen by the patient in the examination room, the medical study support apparatus is inconvenient for the doctor to handle. Therefore, the above-mentioned protective actions have adversely affected the efficiency of the working environment around the doctors.

### SUMMARY OF THE INVENTION

In view of the foregoing problems, an object of the present invention is to protect patients' privacy without reducing the work efficiency of environmental conditions for the doctor.

A medical study support apparatus of the present invention comprises a display device for displaying a study list on a screen, the study list containing data on medical studies of a plurality of patients; and a display controlling device for executing a non-display process of concealing all or part of personal information on the patients among the data contained in the study list while the display device is displaying the study list.

Preferably, all or part of personal information on all patients on the study list except but a designated patient is concealed through the non-display process. Preferably, at least names of the patients are concealed as the personal information through the non-display process.

The study list preferably contains data on study schedule for unfinished medical studies, and data on progress of respective medical studies.

The non-display process makes the personal information invisible by blanking, ciphering, obscuring or shading it, or makes a display field for the personal information disappear from the study list on the screen.

The medical study support apparatus preferably comprises a device for receiving a trigger signal from an external apparatus, which is preferably an electronic chart apparatus for displaying medical chart data of the patients on a monitor. In this embodiment, the display controlling device is provided with a cooperation mode for executing the non-display process in conjunction with the external apparatus upon receipt of the trigger signal. More preferably, the medical study support apparatus comprises a switching device for switching the cooperation mode on or off.

The medical study support apparatus preferably comprises an operating device for entering a command to execute the non-display process, wherein the display controlling device executes the non-display process in response to the command.

A study list display method comprising steps of displaying a study list on a screen, the study list containing data on medical studies of a plurality of patients; and executing a non-display process of concealing all or part of personal information on the patients among the data contained in the study list while the study list is being displayed on the screen.

The present invention makes it possible to conceal all or part of personal information on the patients among the data contained in the study list while the study list is being displayed on the screen. Thus, the privacy of the patients is protected without lowering the efficiency of doctor's working environment.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram illustrating a medical study support apparatus and an electronic chart apparatus;

FIG. 2 is a schematic block diagram illustrating the medical study support apparatus;

FIG. 3 is an example of a study list display screen;

FIG. 4 is an example of the study list display screen after a non-display process;

FIG. 5 is a flowchart illustrating a sequence of executing the non-display process;

FIG. 6 is another example of a study list display screen after a non-display process; and

FIG. 7 is still another example of a study list display screen after a non-display process.

### DESCRIPTION OF THE PREFERRED EMBODIMENTS

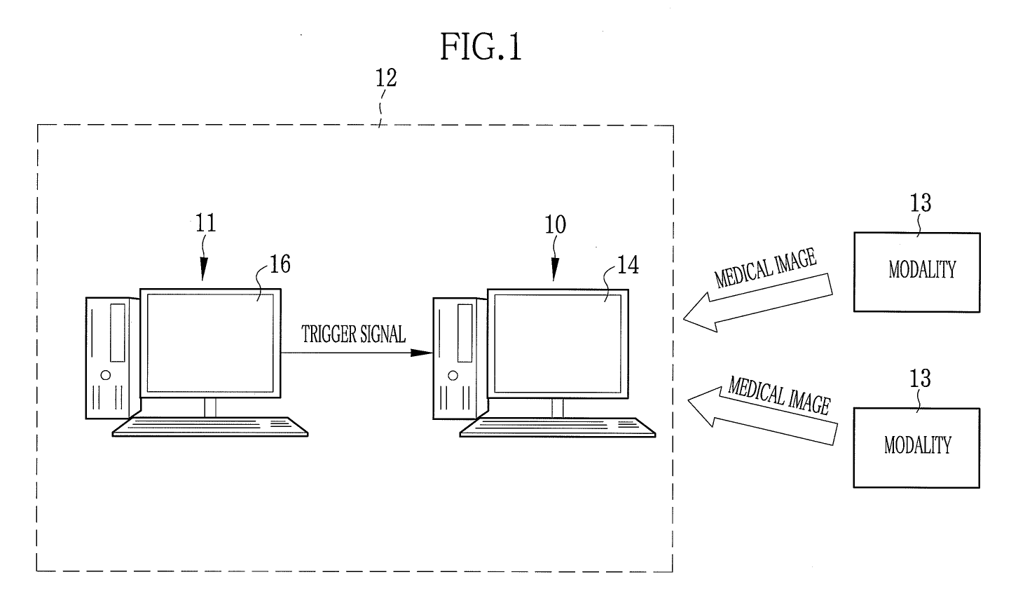

As shown in FIG. 1, a medical study support apparatus 10 an electronic chart apparatus 11 are placed side by side in a place convenient for a doctor to handle them, for example, on the doctor's desk in an examination room 12 of a clinic or hospital. The medical study support apparatus 10 is provided with a study data managing function, receiving information on orders for studies performed by modalities 13 such as a CR device and an endoscope device and managing information on the studies including study schedule. The medical study support apparatus 10 is also provided with a function as an image server, receiving and storing data on medical images taken by the respective modalities 13. The medical study support apparatus 10 has a monitor 14 to display a study list enumerating the study data about many patients, or a medical image of an appointed patient.

The electronic chart apparatus 11 manages information on patients' charts, receiving and storing data of medical chart input thereto, reading out the stored chart data, and displaying the medical chart data on a monitor 16. The medical study support apparatus 10 and the electronic chart apparatus 11 are connected to each other via a Local Area Network (LAN) so that they can communicate with each other. The electronic chart apparatus 11 sends a trigger signal to the medical study support apparatus 10, when the medical chart data of a certain patient is specified and displayed on the monitor 16. In conjunction with the trigger signal, the medical study support apparatus 10 executes a non-display process of concealing part of the study list displayed on the monitor 14.

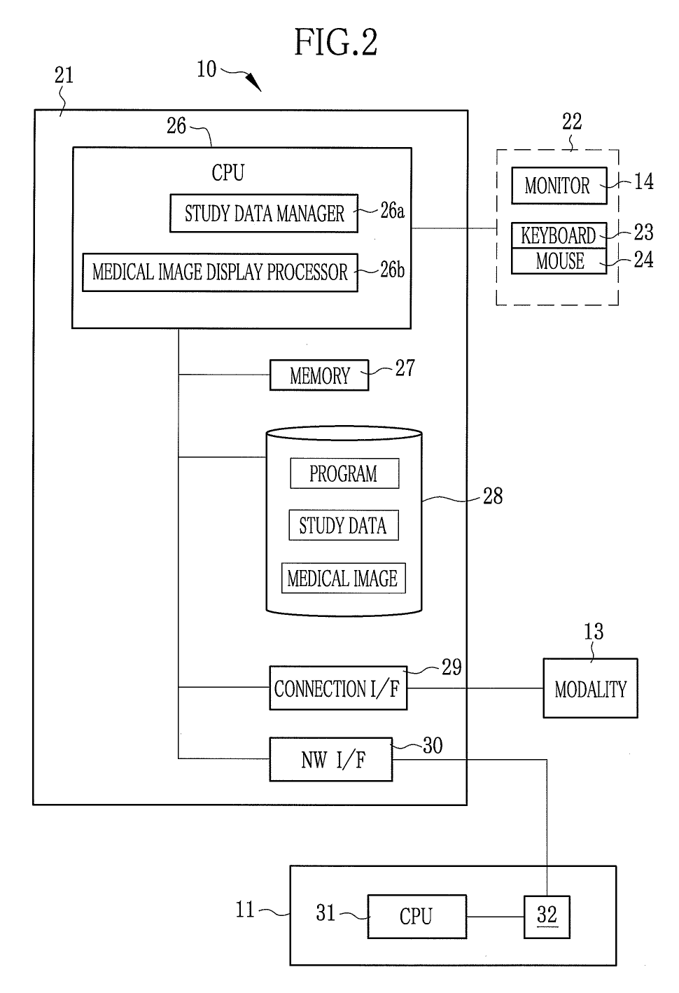

As shown in FIG. 2, the medical study support apparatus 10 is based for example on a personal computer or a workstation, installed with a medical study support program, and consists of a body 21 and a console 22. The console 22 is provided with a monitor 14 and an input device such as a keyboard 23 and a mouse 24.

The body 21 consists of a central processing unit (CPU) 26, a memory 27, a hard disk drive (HDD) 28, a connection I/F 29 and a network I/F 30. The network I/F 30 controls communication according to a communications protocol of the LAN when sending and receiving data via the LAN. The connection I/F 29 is an interface for data communication with the modalities 13. The HDD 28 is a well-known data storage device and stores the study data and medical image data as well as an operating system and such an application program as a medical study support program. The memory 27 is a working memory for the CPU 21 to execute processes.

According to this embodiment, the medical images are stored in the HDD 28. It is, however, possible to provide the medical study support apparatus 10 with a media drive, which accesses a data storage medium like a DVD medium to read and write the data, so that the medical image data can be stored in and read out from the data storage medium. It is also possible to provide an access to an outer image server via a LAN, to read and write the medical image data.

The CPU 26 controls the overall operation of every part of the apparatus and functions as a study data manager 26a and a medical image display processor 26b with the running medial study support program. The medical image display processor 26b reads out the medical image data from the HDD 28 and redisplays the medical image on the monitor 14. The study data manager 26a executes a reception process of receiving orders for studies and a display process of displaying a list of the received study orders on the monitor 14. The study data manager 26a also functions as a display controlling device for executing the above-mentioned non-display process.

Like the medical study support apparatus 10, the electronic chart apparatus 11 is based for example on a personal computer or a workstation, installed with an electronic chart program. When displaying the medical chart data selected through a console 32 on the monitor 16, a CPU 31 in the electronic chart apparatus 11 sends a patient ID, which is information specifying the patient corresponding to the chart data, and the trigger signal through a network I/F 32 to the medical study support apparatus 10. The trigger signal is a command signal for the medical study support apparatus 10 to execute the non-display process. The non-display process is to blank or conceal personal information of all patients other than the patient specified by the patient ID among the personal information contained in the study list.

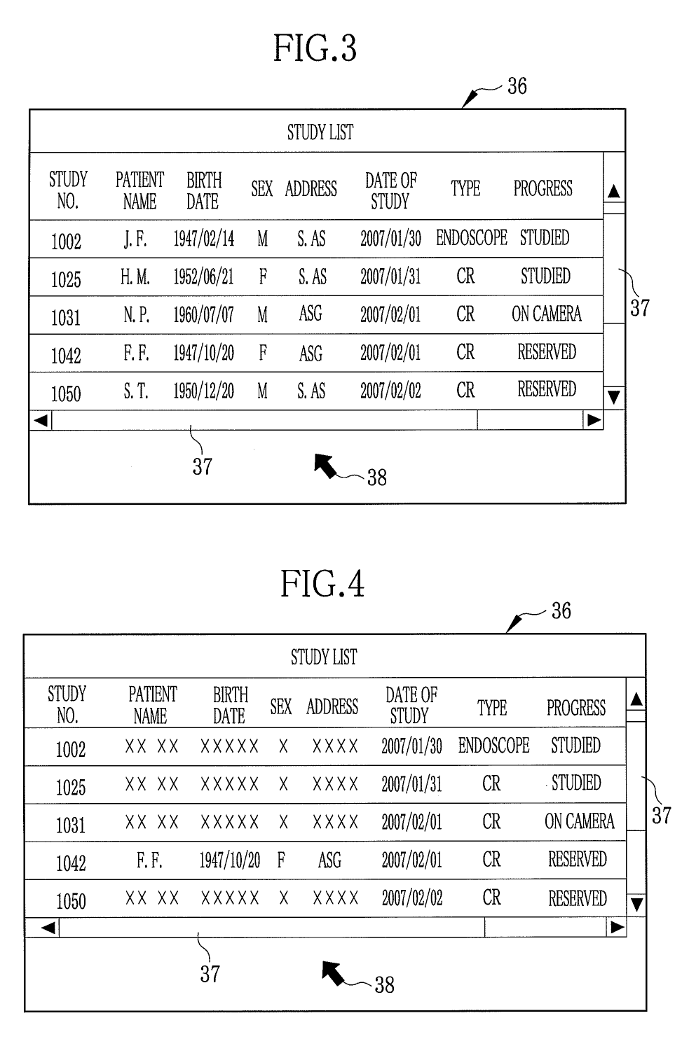

FIG. 3 illustrates an example of a study list display screen 36 displayed on the monitor 14. The study list display screen 36 displays the study list. In the study list, data items about the individual study, including patient's personal information such as its name, birth date, sex and address as well as study items such as study ID, study date, study type and progress of study, are displayed in a lined for one case after another.

As the study type, the type of the individual study such as the CR or the endoscope is displayed. As the study progress, the list notifies the progress of individual study: finished (or inspected), under study (or on camera), or unfinished (or reserved). As the items of the study data, other appropriate items including patient's telephone number, output point of the medical image and the imaged body site may be added to the above-mentioned items. Moreover, it is also possible to predetermine and change the items to be displayed on the list. Scroll bars 37 are provided along a side margin and a bottom margin of a display area of the study list. By operating a slider of the scroll bars with a pointer 38 of the mouse 24 and scrolling the screen from side to side or up and down, it is possible to display those items and study data which are outside the display area.

FIG. 4 illustrates an example of the study list display screen 36 after the non-display process executed in response to the trigger signal as received by the study data manager 26a from the electronic chart apparatus 11. In this example, the patient ID received with the trigger signal designates the study data about a study No. 1042, which is for a patient named, for example, Fumiko Fuji (F.F.). Then, the personal information on other patients than the specified patient is under the non-display process. Through the non-display process, the personal information of other patients than the specified patient is made invisible among the listed study data. In the illustrated example, each letter of such information that is not to be displayed is ciphered or replaced with “X”, but it is possible to use other appropriate codes, like circle, triangle etc., to make the information unreadable.

The non-display process is executed exclusively on the personal information and the other study data is exempt from the non-display process. Therefore, even after the non-display process, it is possible to check the study schedule and the progress of respective studies, like how many studies are reserved at present, what types of studies they are, or which case is under study or on camera.

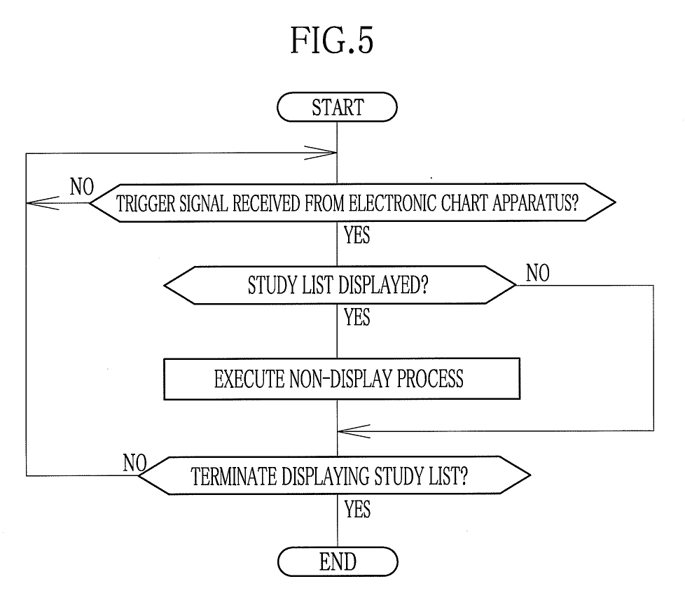

Now the operation of the above described embodiment will be described with reference to a flowchart shown in FIG. 5. As a doctor calls a patient into the examination room 12, the doctor selects to display the medical chart data of the called patient on the monitor 16 of the electronic chart apparatus 11. On this occasion, the electronic chart apparatus 11 sends the trigger signal and the patient ID of the called patient to the medical study support apparatus 10. If the medical study support apparatus 10 is displaying the study list on the monitor 14 when it receives the trigger signal, the medical study support apparatus 10 executes the non-display process.

Through the non-display process, the personal information of all the other patients than the specified patient is made invisible or unreadable on the study list. Thereby, even if the medical study support apparatus 10 is apposed close to the electronic chart apparatus 11, the patient in the doctor's examination room 12 is hindered from watching the personal information of other patients. Thus, patients' privacy is protected. The doctor can also check the study list on the medical study support apparatus 10, to figure out the study schedule and reservation availability for a new study regardless of the patient's eyes during the examination. Therefore, the medical study support apparatus 10 protects the patients' privacy without spoiling effective work environment for the doctor.

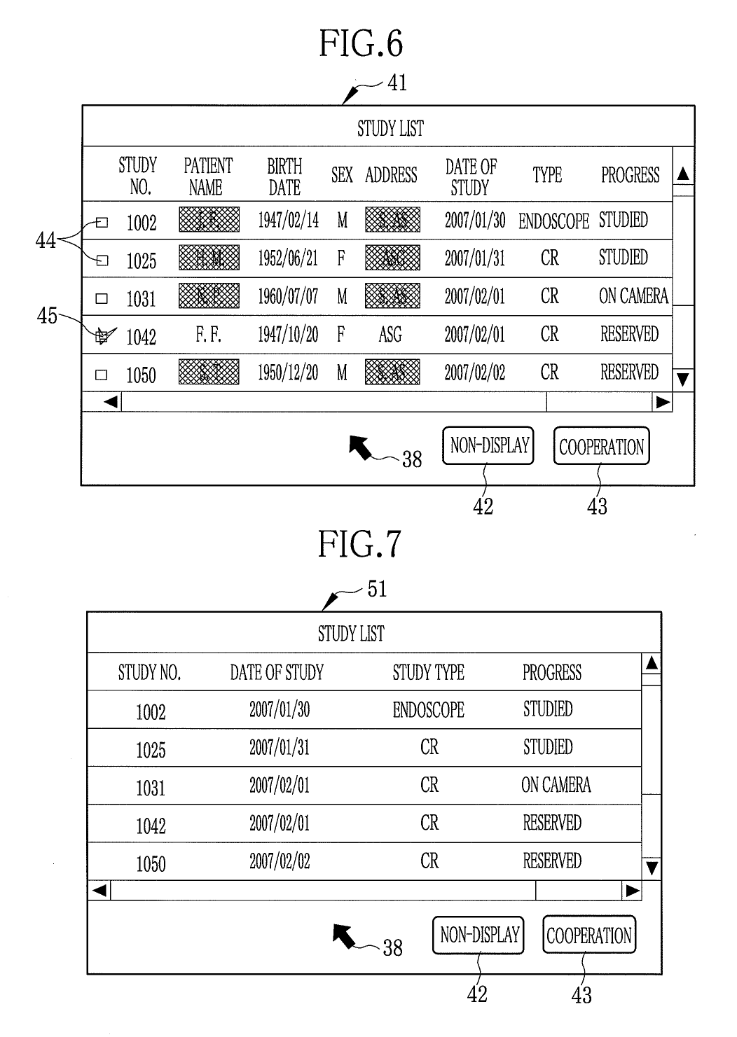

In the above described embodiment, the target information of the non-display process is ciphered. Alternatively, as shown by a study list display screen 41 in FIG. 6, it is possible to make the target information unreadable or invisible by obscuring or shading it. The target of the non-display process can also be limited to certain items such as patients' names and addresses, instead of all of the personal information on other patients than the patient in the examination room, like as shown in FIG. 6. Because it is hard to identify an individual person only by its birth date and sex, it is no problem to limit the target of the non-display process to certain information items. As the patient's name is a representative item of the personal information that specifies the individual, at least the patients' names should be included in the target of the non-display process.

Besides, a non-display button 42 and a cooperation button 43 are provided inside the study list display screen 41. The cooperation button 43 is an operation button for switching a cooperation mode on or off. While the cooperation mode is on, the medical study support apparatus 10 executes the non-display process in conjunction with the electronic chart apparatus 11 in the same way as the above described embodiment. Because the non-display process is necessary only while the patient is in the doctor's examination room 12, it is convenient for the doctor to switch the cooperation mode off on operating the medical study support apparatus 10 while there is no patient in the doctor's examination room 12. The cooperation button 43 allows the doctors to switch the cooperation mode on and off at their convenience.

The non-display button 42 is an operation button for giving a command to execute the non-display process from the console 22, regardless of the trigger signal from the electronic chart apparatus 11. On this occasion, the study list display screen 41 is provided with checkboxes 44 corresponding to the respective patients' study data. Entering a check 45 in one of the checkboxes 44 by a pointer 38 is designating the patient. Clicking the non-display button 42 in this state executes the non-display process, concealing the personal information of other patients than the designated patient away from the screen 41.

It is possible to provide either the non-display button 42 or the interlock button 43 and not always necessary to provide both of them. According to the above described embodiment, the non-display button 42 and the interlock button 43 are the operation buttons displayed on the monitor 14, but it is possible to provide special buttons corresponding to the non-display button 42 and the interlock button 43 on the keyboard 23 or the like.

Moreover, it is possible to provide the medical study support apparatus 10 with the non-display button without providing the cooperation mode with the electronic chart apparatus 11, or it is possible to provide both the non-display button and the cooperation mode.

In the above described embodiments, the non-display process has only the personal information of the designated patient displayed and conceals the personal information of other patients. However, the non-display process is not limited to the above embodiment, but it is possible to conceal the personal information of all the patients on the list away from the screen, as shown for example in a study list display screen 51 in FIG. 7. On this occasion, indeed the doctor cannot identify the study data of the patient during an examination, but can see the study schedule and check the availability of reserving studies.

According to the embodiment of FIG. 7, the personal information is made invisible by making the whole display field for the personal information disappear from the study list display screen 51.

In the above described embodiment, the trigger signal of commanding the non-display process is sent out at the timing when the medical chart data is displayed on the monitor 14 of the electronic chart apparatus 10. The timing of sending out the trigger signal is not limited to this embodiment, but may be any timing when a patient is designated by the electronic chart apparatus, like when a patient is chosen from the chart list.

In the above described embodiment, an external apparatus that gives the trigger signal to the medical study support apparatus is the electronic chart apparatus. Beside the electronic chart apparatus, a terminal equipment for executing an examination reception process or an order issuing terminal equipment for issuing study orders, e.g., a Radiation Information management System (RIS), may also be used as the external apparatus.

In the above described embodiment, the medical study support apparatus of the present invention is provided with the function of displaying the medical images as well as the function of displaying the study list. However, the medical study support apparatus can be provided with only the function of displaying the study list. It is also possible to incorporate the functions of the medical study support apparatus of the present invention into another apparatus. Obviously, as shown in the above described embodiment, the present invention is applicable to program forms and storage media storing the programs as well.

As described so for, the present invention is not to be limited to the above embodiments but, on the contrary, various modifications will be possible without departing from the scope of claims appended hereto.

What is claimed is:

1. A medical study support apparatus comprising:
a display device for displaying a study list on a screen, said study list containing data on medical studies of a plurality of patients; and
a display controlling device for executing a non-display process of concealing all or part of personal information on the patients among the data contained in said study list while said display device is displaying said study list.

2. A medical study support apparatus as recited in claim 1, wherein all or part of personal information on all patients on said study list except a designated patient is concealed through said non-display process.

3. A medical study support apparatus as recited in claim 1, wherein at least names of the patients are concealed as the personal information through said non-display process.

4. A medical study support apparatus as recited in claim 1, wherein said study list contains data on study schedule for unfinished medical studies.

5. A medical study support apparatus as recited in claim 1, wherein said study list contains data on progress of respective medical studies.

6. A medical study support apparatus as recited in claim 1, wherein said non-display process makes the personal information invisible by blanking, ciphering, obscuring or shading it.

7. A medical study support apparatus as recited in claim 1, wherein said non-display process makes a display field for the personal information disappear from said study list on the screen.

8. A medical study support apparatus as recited in claim 1, further comprising a device for receiving a trigger signal from an external apparatus, wherein said display controlling device is provided with a cooperation mode for executing said non-display process in conjunction with said external apparatus upon receipt of said trigger signal.

9. A medical study support apparatus as recited in claim 8, wherein said external apparatus is an electronic chart apparatus for displaying medical chart data of the patients on a monitor.

10. A medical study support apparatus as recited in claim 8, further comprising a switching device for switching said cooperation mode on or off.

11. A medical study support apparatus as recited in claim 10, wherein said switching device is an operation button displayed on the screen of said display device.

12. A medical study support apparatus as recited in claim 8, wherein said trigger signal is sent to said medical study support apparatus when a particular patient is designated on said external apparatus, whereas said display controlling device makes at least personal information on other patients than the designated patient invisible through said non-display process in response to said trigger signal.

13. A medical study support apparatus as recited in claim 1, further comprising an operating device for entering a command to execute said non-display process, wherein said display controlling device executes said non-display process in response to said command.

14. A medical study support apparatus as recited in claim 13, wherein said operating device is an operation button displayed on the screen of said display device.

15. A study list display method comprising steps of:
displaying a study list on a screen, said study list containing data on medical studies of a plurality of patients; and
executing a non-display process of concealing all or part of personal information on the patients among the data contained in said study list while said study list is being displayed on the screen.

16. A study list display method as recited in claim 15, wherein said non-display process is executed in response to a trigger signal received from an external apparatus.

17. A study list display method as recited in claim 15, wherein said non-display process is executed in response to a command entered through an operating device.
